(19) United States
(12) Patent Application Publication
(10) Pub. No.: US 2015/0159409 A1
(43) Pub. Date: Jun. 11, 2015

(54) AFFIXATION DEVICE FOR VEHICLE DOOR

(71) Applicant: AISIN SEIKI KABUSHIKI KAISHA, Kariya-shi, Aichi-ken (JP)

(72) Inventors: Akira Muramatsu, Chiryu-shi (JP); Kosuke Tsukamoto, Anjo-shi (JP); Yoshiki Odaka, Kariya-shi (JP)

(73) Assignee: AISIN SEIKI SABUSHIKI KAISHA, Kariya-shi (JP)

(21) Appl. No.: 14/413,969

(22) PCT Filed: Aug. 27, 2013
(86) PCT No.: PCT/JP2013/072833

§ 371 Date: Jan. 9, 2015

(30) Foreign Application Priority Data
Sep. 7, 2012 (JP) 2012-197089

(51) Int. Cl. E05B 85/20

(52) U.S. Cl. CPC E05B 85/20

(57) ABSTRACT

A vehicle door fixing device is provided with a door lock striker arranged in a first panel that is one of a vehicle body panel and a door panel, and a latch mechanism arranged in a second panel that is the other of the vehicle body panel and the door panel. The latch mechanism is capable of holding the vehicle door in a closed state by being engaged with the door lock striker. A wedge and an urging member are arranged in the second panel. An inclined surface arranged in the wedge contacts the door lock striker by a closing operation of the vehicle door. A contact portion arranged in the door lock striker contacts the inclined surface of the wedge. The urging member presses the wedge in the direction in which the inclined surface of the wedge is pressed against the contact portion of the door lock striker.

### TECHNICAL FIELD

The present invention relates to a vehicle door fixing device.

### BACKGROUND ART

Conventionally, a vehicle door fixing device is known in which a door lock striker, which is arranged in one of a vehicle door (door panel) and a door opening section (vehicle body panel), is engaged with a latch mechanism of a door lock assembly, which is arranged in the other of the vehicle door and the door opening section, by a closing operation of the vehicle door. The engagement allows the vehicle door fixing device to fix the vehicle door in a closed state.

For example, Patent Document 1 discloses such a vehicle door fixing device. In this device, each of a vehicle body panel and a door panel includes a wedge. The wedges include inclined surfaces that come into contact with each other by a closing operation of the vehicle door. One of the wedges is urged to be pressed against the other.

The pressing force between the two inclined surfaces that are in contact with and pressed against each other presses the closed vehicle door in a direction intersecting the open and close direction of the vehicle door, for example, toward a hinge that functions as a pivot of the vehicle door. This reduces rattle of the vehicle door with the simple structure.

### PRIOR ART DOCUMENTS

### Patent Documents

Patent Document 1: Japanese Laid-Open Patent Publication No. 2012-97495

### SUMMARY OF THE INVENTION

### Problems That the Invention is to Solve

However, the shapes of vehicle body panels and door panels differ among vehicle types. Thus, the shapes of components such as a wedge that is arranged on the surface of the panel and a bracket that fixes the wedge need to be changed to conform to the shapes of the panels. This may complicate the part number management of the components and may increase the manufacturing costs. In this regard, improvements are desired.

It is an object of the present invention to provide a vehicle door fixing device that reduces restrictions related to the panel shape and has high installation flexibility.

### Means for Solving the Problems

To achieve the foregoing objective, a vehicle door fixing device includes a door lock striker, a latch mechanism, a wedge, an inclined surface, a contact portio, and an urging member. The door lock striker is adapted to be arranged in a first panel that is one of a vehicle body panel and a door panel. The latch mechanism is adapted to be arranged in a second panel that is the other one of the vehicle body panel and the door panel. The latch mechanism is adapted to hold a vehicle door in a closed state by being engaged with the door lock striker. The wedge is adapted to be arranged in the second panel. The inclined surface is located in the wedge and adapted to contact the door lock striker by a closing operation of the vehicle door. The contact portion is located in the door lock striker and contacts the inclined surface of the wedge. The urging member is adapted to be arranged in the second panel. The urging member urges the wedge in a direction that presses the inclined surface of the wedge against the contact portion of the door lock striker.

In the structure described above, the pressing force of the inclined surface of the wedge and the contact portion of the door lock striker against each other presses the closed vehicle door in a direction intersecting the open and close direction of the vehicle door. Thus, rattle of the vehicle door is reduced with the simple structure.

Moreover, compared to a conventional structure in which both the vehicle body panel and the door panel include a wedge, the installation of the wedge is facilitated. This reduces the manufacturing costs.

The door lock striker preferably includes a first leg, a second leg, and a connection portion. The latch mechanism is engageable with the first leg. The first leg includes a projection end. The second leg is adapted to be located at a position farther from the wedge than the first leg is when the vehicle door is held in the closed state. The second leg includes a projection end. The connection portion connects the projection end of the first leg to the projection end of the second leg and includes the contact portion.

Such a structure allows the inclined surface of the wedge to contact the contact portion of the door lock striker without interfering with the latch mechanism.

A projecting amount of the first leg is preferably less than a projecting amount of the second leg.

Such a structure allows the outer surface (e.g., top section) of the connection portion, which is diagonal to the direction of the relative movement of the door lock striker, to function as the contact portion that contacts the inclined surface of the wedge.

The door lock striker preferably includes an engagement portion that is engageable with the latch mechanism and includes a projection end and a connection portion adapted to connect the projection end of the engagement portion to the first panel. The contact portion is preferably formed in the connection portion.

Such a structure allows the inclined surface of the wedge to contact the contact portion of the door lock striker without interfering with the latch mechanism.

The latch mechanism is preferably adapted to be arranged in the second panel, and the door lock striker is preferably adapted to enter the second panel through a striker entry hole that opens to a surface of the second panel.

Such a structure limits entry of foreign matter (such as dust and dirt) into the movable sections of the wedge, thereby ensuring high reliability. Furthermore, the lubricant (such as grease) applied to the movable sections is prevented from adhering to passengers.

The latch mechanism preferably includes a plastic body and a metal base plate. The plastic body includes a slide surface and defines an accommodation cavity for accommodating the wedge. The wedge is slidable on the slide surface. The metal base plate is fixed to the plastic body and capable of reinforcing the slide surface.

Such a structure ensures that the slide surface for the wedge receives the pressing force between the inclined surface of the wedge and the contact portion of the door lock striker, which are in contact with and pressed against each other. This strengthens the pressing of the vehicle door and thus ensures the reduction in rattle of the vehicle door.

The base plate is preferably adapted to reinforce the slide surface in an entire area on which the wedge slides.

The latch mechanism and the wedge preferably form a door lock assembly.

The contact portion is preferably an inclination portion having an inclination of an angle equal to the angle of an inclination of the inclined surface.

The door lock striker is preferably formed by bending a bar.

### BRIEF DESCRIPTION OF THE DRAWINGS

FIG. 1 is a schematic cross-sectional view showing a vehicle door fixing device of one embodiment;

FIG. 2 is a perspective view showing an end surface of a door opening section and a door lock striker arranged on the end surface;

FIG. 3 is a perspective view showing an end surface of a vehicle door and a striker entry hole that opens to the end surface;

FIG. 4 is a cross-sectional view showing an accommodation cavity defined by a plastic body of a door lock assembly in a door panel and a wedge arranged in the accommodation cavity;

FIG. 5 is an explanatory diagram showing a slide surface formed in the plastic body and an inclination portion of the door lock striker that contacts an inclined surface of the wedge; and

FIG. 6 is a schematic cross-sectional view showing a vehicle door fixing device of another embodiment.

### MODES FOR CARRYING OUT THE INVENTION

A vehicle door fixing device according to one embodiment of the present invention will now be described with reference to the drawings.

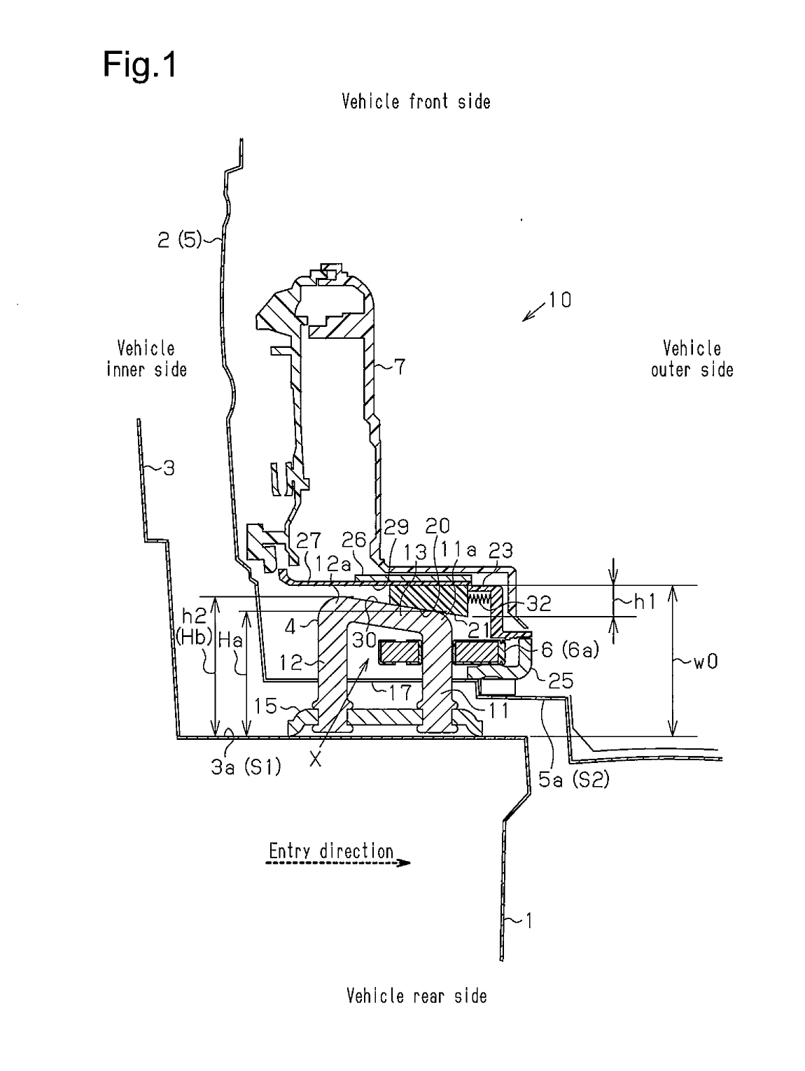

As shown in FIG. 1, a vehicle body panel (side member outer panel) 1, which forms a side surface of a vehicle, includes an end surface 3a that defines a door opening section 3, which is opened and closed by a vehicle door 2. In the following descriptions, the end surface 3a is also referred to as a panel surface S1. A door lock striker 4 is arranged on the panel surface S1 and projects from the panel surface S1. A door panel (door inner panel) 5, which forms the vehicle door 2, is attached to the end surface 3a. The door panel 5 includes a door lock assembly 7 that includes a known latch mechanism 6, which is engaged with and disengaged from the door lock striker 4 by opening and closing operations of the vehicle door 2, and a lock mechanism (not shown), which locks the vehicle door 2 in a closed state. The door lock assembly 7 holds the latch mechanism 6 and the door lock striker 4 in engagement with each other. This allows the vehicle door fixing device 10 of the present embodiment to fix the vehicle door 2 in the closed state.

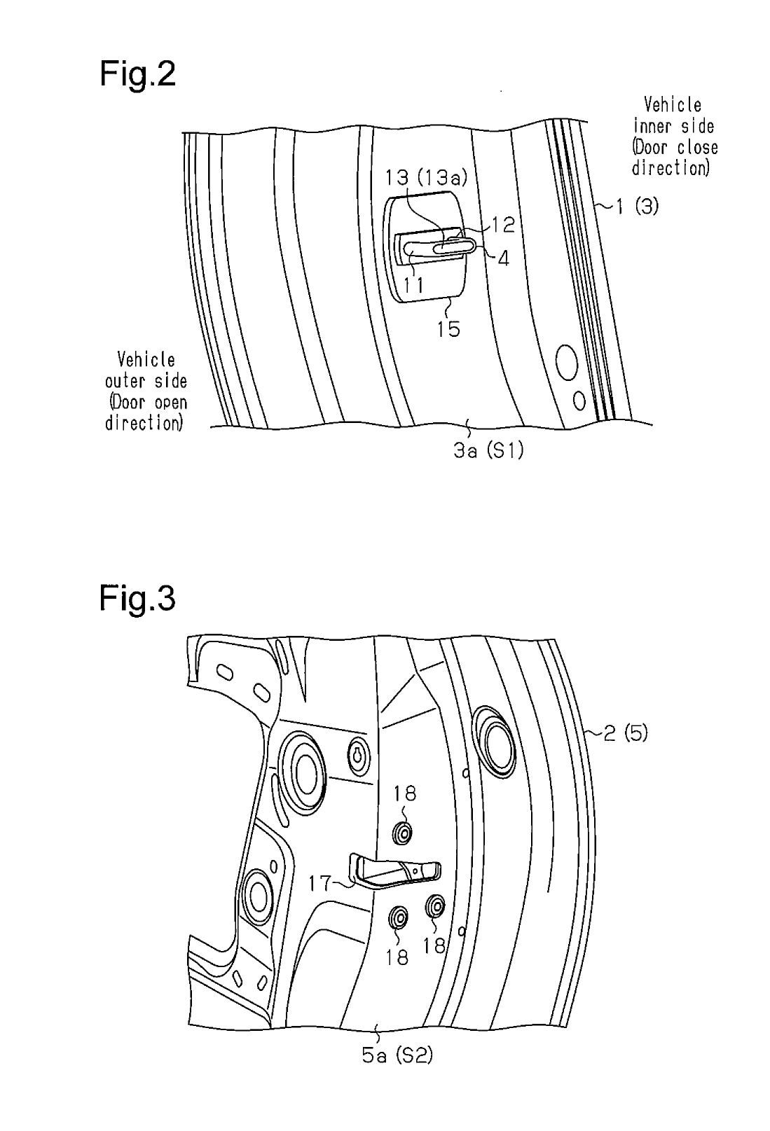

To be more specific, the vehicle door 2 shown in FIG. 1 is a side door on the right side of the vehicle. The vehicle door 2 opens and closes by pivoting about a hinge (not shown) arranged on the end surface of the door opening section 3 on the front side of the vehicle (upper side as viewed in FIG. 1). As shown in FIGS. 1 and 2, the door lock striker 4 of the present embodiment includes two legs 11 and 12, which project from the panel surface S1 of the vehicle body panel 1, and a connection portion 13, which connects projection ends 11a and 12a of the legs 11 and 12. The door lock striker 4 substantially has the shape of letter U. The door lock striker 4 of the present embodiment is formed by bending a bar (metal bar) having a circular cross-section. The door lock striker 4 is fixed to the end surface 3a of the door opening section 3 such that the two legs 11 and 12 are aligned in a direction that is substantially the same as the direction in which the door panel 5 is moved by opening and closing operations of the vehicle door 2 (vehicle inside-outside direction, or sideward direction as viewed in FIG. 1).

Specifically, in the present embodiment, the door lock striker 4 is arranged on a planar base plate 15. When the alignment direction of the two legs 11 and 12 of the door lock striker 4 fixed to the door opening section 3 is defined as “a front-rear direction”, and the direction perpendicular to the front-rear direction is defined as “a lateral direction”, the door lock striker 4 is located in the center section of the base plate 15 in the lateral direction. The door lock striker 4 is fixed integrally with the base plate 15 to the end surface 3a of the door opening section 3.

Further, as shown in FIG. 1, the door panel 5 of the present embodiment includes an end surface 5a on the rear side of the vehicle. The end surface 5a faces the end surface 3a of the door opening section 3 when the vehicle door 2 is closed. In the following descriptions, the end surface 5a is also referred to as a panel surface S2. As shown in FIGS. 1 and 3, the door panel 5 includes a striker entry hole 17 extending in a direction in which the door panel 5 moves relative to the door lock striker 4 (sideward direction as viewed in FIG. 1).

That is, as shown in FIG. 1, in the present embodiment, movement of the vehicle door 2 by an opening or closing operation of the vehicle door 2 causes the legs 11 and 12 of the door lock striker 4, which is arranged on the vehicle body panel 1, to enter or exit the striker entry hole 17, which opens to the panel surface S2 of the door panel 5. In addition, the door lock assembly 7 is fixed at the inner side of the door panel 5 (in the panel) such that a latch 6a of the latch mechanism 6 faces the striker entry hole 17. The latch 6a is engaged with and disengaged from the door lock striker 4.

As shown in FIG. 3, in the present embodiment, a plurality of screws 18 is fastened near the striker entry hole 17. The screws 18 fix the door lock assembly 7 in the door panel 5.

Further, as shown in FIG. 1, the vehicle door fixing device 10 of the present embodiment includes a wedge 21 in the door lock assembly 7. The wedge 21 includes an inclined surface 20 that is brought into contact with the door lock striker 4 by a closing operation of the vehicle door 2.

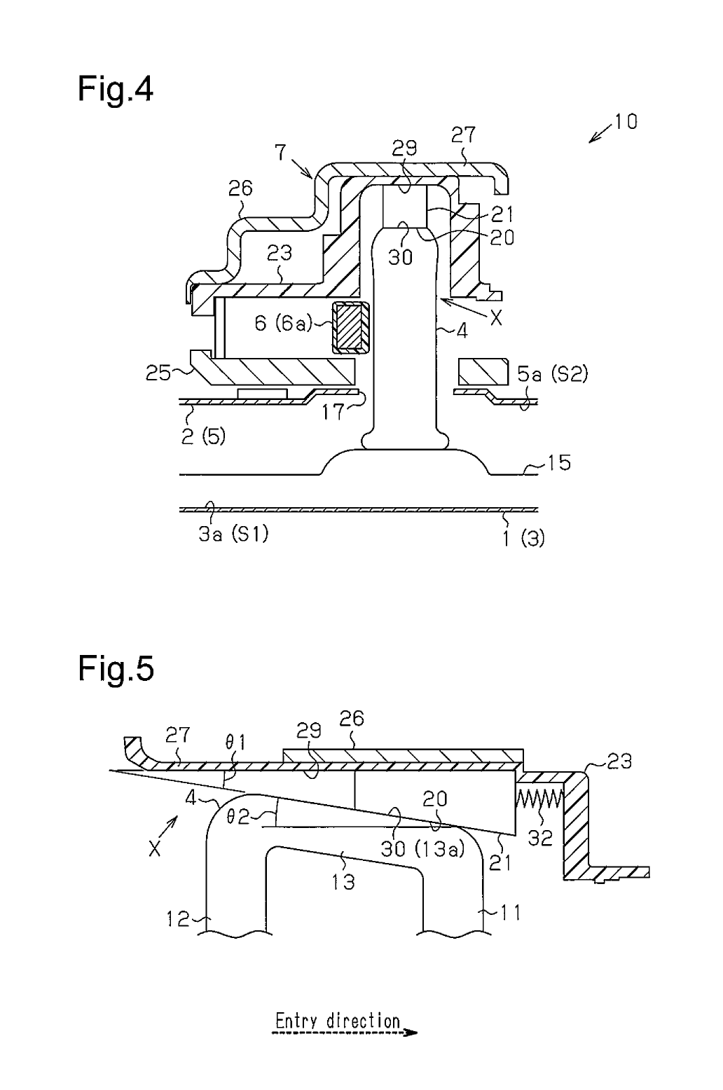

Specifically, as shown in FIGS. 1 and 4, the door lock assembly 7 of the present embodiment includes a plastic body 23 that defines an accommodation cavity X, which is in communication with the striker entry hole 17. The accommodation cavity X accommodates the wedge 21 and the latch 6a.

The door lock assembly 7 includes a pair of base plates 25 and 26 that is fixed to the plastic body 23 such that the plastic body 23 is sandwiched between the base plates 25 and 26. In the present embodiment, the base plate 25 and 26 are made of a metal (such as stainless steel) capable of reinforcing the plastic body 23 when the base plates 25 and 26 are fixed to the plastic body 23. Further, the door lock assembly 7 is fixed to the door panel 5 with the base plate 25 (main base) located near the door panel 5. The base plates 25 and 26 cooperate to support a pivot (not shown) that supports the latch 6a. The plastic body 23 and the base plates 25 and 26 are components of the latch mechanism 6.

The latch 6a is arranged at a position that allows the latch 6a to contact the door lock striker 4, which enters and exits the accommodation cavity X through the striker entry hole 17, more specifically, to contact the leg 11 that is located at the front side in the direction in which the door lock striker 4 moves relative to the striker entry hole 17 when entering the striker entry hole 17 (left to right direction as viewed in FIG. 1). The latch 6a rotates about its pivot so that the door lock assembly 7 (latch mechanism 6) immobilizes the leg 11 that is engaged with the latch 6a.

In addition, the plastic body 23 of the present embodiment includes a planar portion 27 that is parallel to the end surface 5a of the door panel 5 and extends in the extension direction of the striker entry hole 17. The surface of the planar portion 27 (the lower surface as viewed in FIG. 1) that faces the connection portion 13 of the door lock striker 4 in the accommodation cavity X functions as a slide surface 29. The wedge 21 is arranged such that the wedge 21 slides on the slide surface 29 in the entry and exit directions of the door lock striker 4 (sideward direction as viewed in FIG. 1).

In the present embodiment, the base plate 26 (sub-base) is fixed to the plastic body 23 so that the base plate 26 covers the surface of the planar portion 27 that is opposite to the slide surface 29 (upper surface as viewed in FIG. 1). This reinforces the slide surface 29.

The wedge 21 is arranged such that the inclined surface 20 of the wedge 21 faces toward the direction opposite to the entry direction of the door lock striker 4. In addition, a projecting amount h1 of the wedge 21 projecting from the slide surface 29 of the plastic body 23 and a projecting amount h2 (Hb) of the door lock striker 4 projecting from the panel surface S1 of the vehicle body panel 1 are set such that the sum of those heights is greater than a distance w0 between the panel surface S1 and the slide surface 29 in the door closed state (h1+h2>w0). Thus, as shown in FIG. 5, the inclined surface 20 of the wedge 21 comes into contact with the door lock striker 4 that enters the accommodation cavity X by a closing operation of the vehicle door 2, more specifically, with the inclination portion 30 formed in the top section of the connection portion 13 that faces the slide surface 29.

To be more specific, as shown in FIG. 2, the connection portion 13 of the present embodiment includes a flat surface 13a in the top section. In addition, as shown in FIG. 1, the door lock striker 4 of the present embodiment is formed such that a projecting amount Ha of the leg 11, which enters the accommodation cavity X first, is less than a projecting amount Hb of the leg 12, which enters the accommodation cavity X subsequently. In the present embodiment, when the vehicle door 2 is closed, the leg 11 is a first leg that is closer to the wedge 21, and the leg 12 is a second leg that is farther from the wedge 21. As shown in FIG. 5, the flat surface 13a formed in the top section of the connection portion 13 functions as the inclination portion 30 that is inclined from rear to front in the entry direction of the door lock striker 4.

Further, as shown in FIGS. 1 and 5, a coil spring 32 arranged on the plastic body 23 urges the wedge 21 of the present embodiment in the direction opposite to the entry direction of the door lock striker 4 (right to left direction as viewed in FIGS. 1 and 5). The urging force of the coil spring 32 presses the inclined surface 20 of the wedge 21 against the inclination portion 30 of the door lock striker 4.

More specifically, as shown in FIG. 5, in the present embodiment, an inclination θ2 of the inclination portion 30 formed in the door lock striker 4 is set to be an angle substantially the same as an inclination θ1 of the inclined surface 20 of the wedge 21. The inclination θ1 is the angle that the inclined surface 20 of the wedge 21 forms with the slide surface 29 of the plastic body 23 and the end surface 3a of the door opening section 3 (panel surface S1), which extend in the direction in which the vehicle door 2 is moved by an opening or closing operation (sideward direction as viewed in FIG. 5). The inclination θ2 is the angle that the inclination portion 30 of the door lock striker 4 forms with the slide surface 29 and the end surface 3a. The inclinations θ1 and θ2 allow for a larger area of contact between the inclined surface 20 of the wedge 21 and the inclination portion 30 of the door lock striker 4.

Operation of the vehicle door fixing device according to the present embodiment will now be described.

In the present embodiment, a closing operation of the vehicle door 2 brings the inclined surface 20 of the wedge 21 arranged in the door lock assembly 7 into contact with the inclination portion 30 formed in the top section of the connection portion 13 of the door lock striker 4 that enters the door panel 5 through the striker entry hole 17. In addition, an elastic member functioning as urging means (urging member), namely, the coil spring 32, urges the wedge 21 in the direction in which the door panel 5 moves in the closing operation of the vehicle door 2, that is, in the direction opposite to the entry direction of the door lock striker 4. This presses the inclined surface 20 of the wedge 21 against the inclination portion 30 of the door lock striker 4. Accordingly, the pressing force of the inclined surface 20 of the wedge 21 and the inclination portion 30 of the door lock striker 4 against each other presses the closed vehicle door 2 in a direction intersecting the open and close direction of the vehicle door 2.

In the present embodiment, the inclination θ1 of the inclined surface 20 of the wedge 21 and the inclination θ2 of the inclination portion 30 of the door lock striker 4 are set such that the vehicle door 2 is pressed toward the front side of the vehicle (refer to FIG. 1, upper side as viewed in FIG. 1) at which the hinge (not shown) is arranged. Thus, rattle of the vehicle door 2 is reduced with the simple structure.

In addition, the reduction in rattle of the vehicle door 2 allows the vehicle door 2 to function as a structural body (support member) that extends in the front-rear direction of the door opening section 3. This improves the rigidity of the vehicle body, thereby improving the cornering ability of the vehicle.

For example, when the vehicle is turning, centrifugal force causes bending deformation in the vehicle body. However, the wedge 21, which is pressed against the door lock striker 4, moves in conformance to the bending deformation. This maintains the inclined surface 20 of the wedge 21 in contact with the inclination portion 30 of the door lock striker 4. Thus, the bending deformation is minimized.

The advantages of the present embodiment will now be described.

(1) The vehicle door fixing device 10 includes the wedge 21, which includes the inclined surface 20. The inclined surface 20 is brought into contact with the door lock striker 4 by a closing operation of the vehicle door 2. In addition, the door lock striker 4 includes the inclination portion 30, which contacts the inclined surface 20 of the wedge 21. The wedge 21 is urged in the direction that presses the inclined surface 20 against the inclination portion 30 of the door lock striker 4.

In the structure described above, the pressing force of the inclined surface 20 of the wedge 21 and the inclination portion 30 of the door lock striker 4 against each other presses the closed vehicle door 2 in a direction intersecting the open and close direction of the vehicle door 2. Thus, rattle of the vehicle door 2 is reduced with the simple structure.

The wedge 21 is a component of the door lock assembly 7. Thus, the shapes of the vehicle body panel 1 and the door panel 5 are less likely to hinder the installation of the wedge 21. This reduces restrictions related to the panel shape and increases flexibility in the installation of the wedge 21. Moreover, compared to a conventional structure in which both the vehicle body panel 1 and the door panel 5 include a wedge, the installation of the wedge 21 is facilitated. This reduces the manufacturing costs.

(2) The door lock striker 4 includes the first leg 11, which is engageable with the latch mechanism 6, the second leg 12, which is farther from the wedge 21 than the first leg 11 when the vehicle door 2 is held in the closed state, and the connection portion 13, which connects the projection end of the first leg 11 and the projection end of the second leg 12 and includes the inclination portion 30. In the closing operation of the vehicle door 2, the leg 11, which is closer to the wedge 21, is engaged with the latch 6a. The inclination portion 30 is formed in the top section of the connection portion 13. This allows the inclined surface 20 of the wedge 21 to contact the inclination portion 30 of the door lock striker 4 without interfering with the latch mechanism 6 (latch 6a).

(3) In the closing operation of the vehicle door 2, the projecting amount Ha of the leg 11 of the door lock striker that is closer to the wedge 21 is less than the projecting amount Hb of the other leg 12. This allows the outer surface (top section) of the connection portion 13, which is diagonal to the relative movement direction of the door lock striker, to function as the inclination portion 30, which contacts the inclined surface 20 of the wedge 21.

(4) The door lock assembly 7 is arranged in the door panel 5. In addition, the door panel 5 includes the striker entry hole 17, which opens to the panel surface S2. The door lock striker 4 enters the door panel 5 through the striker entry hole 17.

Such a structure limits entry of foreign matter (such as dust and dirt) into the movable sections of the wedge 21 (such as the coil spring 32 and the border between the wedge 21 and the slide surface 29). This ensures high reliability. Furthermore, the lubricant (such as grease) applied to the movable sections is prevented from adhering to passengers.

(5) The door lock assembly 7 includes the plastic body 23 that defines the accommodation cavity X, which is in communication with the striker entry hole 17. The accommodation cavity X accommodates the wedge 21 and the latch 6a. The plastic body 23 includes the slide surface 29 for the wedge 21. In addition, the metal base plate 26 (sub-base), which reinforces the slide surface 29, is fixed to the plastic body 23.

Such a structure ensures that the slide surface 29 for the wedge 21 receives the pressing force between the inclined surface 20 of the wedge 21 and the inclination portion 30 of the door lock striker 4 that are in contact with and pressed against each other. This strengthens the pressing of the vehicle door 2 and thus ensures the reduction of rattle of the vehicle door 2.

(6) The base plate 26 reinforces the slide surface 29 in the entire area on which the wedge 21 slides.

Such a structure improves the operation reliability of the wedge 21. The situation in which “the base plate reinforces the slide surface in the entire area on which the wedge slides” is not limited to the situation in which the entire base plate 26 covers the slide surface 29. As long as the base plate 26 reinforces the slide surface 29 as a whole, a section of the base plate 26 may include a hole, for example. In addition, the reinforcement may be achieved by either of a single end support structure and a both end support structure.

(7) The door lock assembly 7 includes the latch mechanism 6, the wedge 21, and the lock mechanism.

In such a structure, the latch mechanism 6, the wedge 21, and the lock mechanism are integrated as components of the door lock assembly 7. This is advantageous in reducing the size and the manufacturing costs.

(8) The inclination portion 30 (contact portion) of the door lock striker 4 has an inclination of an angle substantially equal to the inclination of the inclined surface 20 of the wedge 21.

Such a structure ensures a larger area of contact between the inclination portion 30 of the door lock striker 4 and the inclined surface 20 of the wedge 21.

(9) The door lock striker 4 is formed by bending a bar.

Such a structure eliminates the need for a separate member for forming the inclination portion 30 (contact portion) of the door lock striker 4. This simplifies the vehicle door fixing device.

The above described embodiment may be modified as follows.

In the above embodiment, the door lock striker 4 is arranged in the vehicle body panel 1, and the door lock assembly 7 is arranged in the door panel 5. However, the door lock assembly 7 may be arranged in the vehicle body panel 1, and the door lock striker 4 may be arranged in the door panel 5.

In the above embodiment, the vehicle door fixing device 10 is used for the vehicle door 2, which pivots on the hinge to open and close, specifically, a side door on the right side of the vehicle. However, the vehicle door fixing device 10 may be used for a slide door and a back door that opens and closes an opening in the rear end of the vehicle.

In the above embodiment, the door lock striker 4 includes the inclination portion 30 in the top section of the connection portion 13 that faces the slide surface 29. The inclination portion 30 is inclined from rear to front in the entry direction of the door lock striker 4. A closing operation of the vehicle door 2 brings the inclination portion 30 into contact with the inclined surface 20 of the wedge 21. However, the contact portion that contacts the inclined surface 20 of the wedge 21 is not limited to the inclination portion 30. For example, the bent section of the connection portion between the leg 11 and the connection portion 13 may function as the contact portion.

In the above embodiment, the door lock assembly 7 is fixed in the door panel 5. However, the door lock assembly 7 may be fixed to the door panel 5 such that at least a portion of the door lock assembly 7 is exposed from the panel surface S2. As long as the wedge 21 is formed integrally with the door lock assembly 7, the wedge 21 may be exposed out of the panel.

In the above embodiment, the coil spring 32, which is the elastic member, functions as the urging means (urging member) of the wedge 21. However, a spring other than the coil spring 32 or an elastic member other than a spring may be used to urge the wedge 21.

In the above embodiment, the projecting amount Ha of the leg 11, which is closer to the wedge 21, is less than the projecting amount Hb of the other leg 12. The flat surface 13a formed in the top section of the connection portion 13, which connects the projection ends 11a and 12a of the legs 11 and 12, forms the inclination portion 30, which is inclined from rear to front in the entry direction of the door lock striker 4. However, the top section of the connection portion 13 does not have to be flat. That is, the inclination portion 30 may be curved. In addition, as long as the door lock striker 4 includes the contact portion (inclination portion 30) that contacts the inclined surface 20 of the wedge 21, the door lock striker 4 may have any shape. For example, the connection portion 13 does not have to extend diagonally to the relative movement direction of the door lock striker 4. Further, the inclination portion 30 may be formed in a section other than the connection portion 13 (such as the rear leg 12).

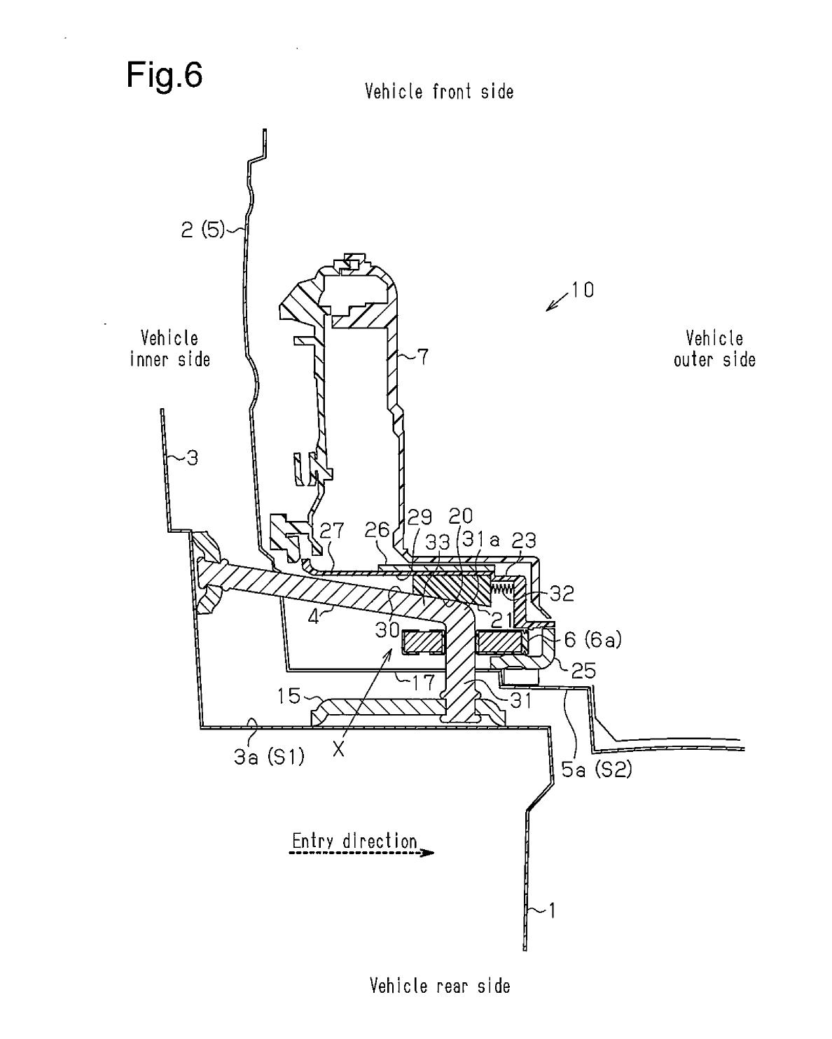

Furthermore, as shown in FIG. 6, the door lock striker 4 may substantially have the shape of letter L and include an engagement portion 31 and a connection portion 33. The engagement portion 31 projects from the panel surface S1 to be engageable with the latch 6a of the latch mechanism 6. The connection portion 33 connects a projection end 31a of the engagement portion 31 and the vehicle body panel 1. The connection portion 33 may be inclined from rear to front in the entry direction of the door lock striker 4 and form the inclination portion 30 that functions as the contact portion for the inclined surface 20 of the wedge 21.

1. (canceled)

2. (canceled)

3. (canceled)

4. (canceled)

5. (canceled)

6. (canceled)

7. (canceled)

8. (canceled)

9. (canceled)

10. (canceled)

11. A vehicle door fixing device comprising:
a door lock striker adapted to be arranged in a first panel that is one of a vehicle body panel and a door panel;
a latch mechanism adapted to be arranged in a second panel that is the other one of the vehicle body panel and the door panel, wherein the latch mechanism is adapted to hold a vehicle door in a closed state by engaging the door lock striker;
a wedge adapted to be arranged in the second panel;
an inclined surface that is located in the wedge and adapted to contact the door lock striker by a closing operation of the vehicle door;
a contact portion that is located in the door lock striker and contacts the inclined surface of the wedge; and
an urging member adapted to be arranged in the second panel, wherein the urging member urges the wedge in a direction that presses the inclined surface of the wedge against the contact portion of the door lock striker, wherein
the contact portion includes an inclination portion that is inclined in an entry direction of the door lock striker, and
the inclination portion is formed by a flat surface.

12. The vehicle door fixing device according to claim 11, wherein the door lock striker includes:
a first leg with which the latch mechanism is engageable, wherein the first leg includes a projection end;
a second leg adapted to be located at a position farther from the wedge than the first leg is when the vehicle door is held in the closed state, wherein the second leg includes a projection end; and
a connection portion that connects the projection end of the first leg to the projection end of the second leg and includes the contact portion.

13. The vehicle door fixing device according to claim 12, wherein a projecting amount of the first leg is less than a projecting amount of the second leg.

14. The vehicle door fixing device according to claim 11, wherein the door lock striker includes;
an engagement portion that is engageable with the latch mechanism and includes a projection end; and
a connection portion adapted to connect the projection end of the engagement portion to the first panel, and
the contact portion is formed in the connection portion.

15. The vehicle door fixing device according to claim 11, wherein
the latch mechanism is adapted to be arranged in the second panel, and
the door lock striker is adapted to enter the second panel through a striker entry hole that opens to a surface of the second panel.

16. The vehicle door fixing device according to claim 11, wherein the latch mechanism includes:
a plastic body that includes a slide surface and defines an accommodation cavity for accommodating the wedge, wherein the wedge is slidable on the slide surface; and
a metal base plate that is fixed to the plastic body and capable of reinforcing the slide surface.

17. The vehicle door fixing device according to claim 16, wherein the base plate is adapted to reinforce the slide surface in an entire area on which the wedge slides.

18. The vehicle door fixing device according to claim 11, wherein the latch mechanism and the wedge form a door lock assembly.

19. The vehicle door fixing device according to claim 11, wherein inclination portion has an inclination of an angle equal to the angle of an inclination of the inclined surface.

20. The vehicle door fixing device according to claim 11, wherein the door lock striker is formed by bending a bar.
